(19) United States
(12) Patent Application Publication
(10) Pub. No.: US 2018/0060562 A1
(43) Pub. Date: Mar. 1, 2018

(54) SYSTEMS AND METHODS TO PERMIT AN ATTEMPT AT AUTHENTICATION USING ONE OR MORE FORMS OF AUTHENTICATION

(71) Applicant: Lenovo (Singapore) Pte. Ltd., New Tech Park (SG)

(72) Inventors: Rod D. Waltermann, Rougemont, NC (US); Joseph Michael Pennisi, Apex, NC (US); Timothy Winthrop Kingsbury, Cary, NC (US); Douglas Warren Robinson, Raleigh, NC (US); Justin Tyler Dubs, Raleigh, NC (US)

(21) Appl. No.: 15/254,091

(22) Filed: Sep. 1, 2016

(51) Int. Cl. G06F 21/44; G06F 21/62

(52) U.S. Cl. CPC G06F 21/44; G06F 21/6218

(57) ABSTRACT

In one aspect, a device includes a processor and storage accessible to the processor. The storage bears instructions executable by the processor to identify at least a first mode of authentication associated with a first predetermined weight, identify at least a second mode of authentication associated with a second predetermined weight, identify a threshold, and permit access at least in part based on the weights meeting the threshold.

### FIELD

The present application relates generally to systems and methods to permit an attempt at authentication using one or more forms of authentication.

### BACKGROUND

As technology progresses, so do malicious hackers seeking to exploit technological vulnerabilities that secure a given system. As recognized herein, current safeguards are inadequate for addressing the foregoing computer-related problem.

### SUMMARY

Accordingly, in one aspect a device includes a processor and storage accessible to the processor. The storage bears instructions executable by the processor to identify one or more forms of authentication each associated with a respective predetermined weight, with the identification of the one or more forms of authentication being based at least in part on the sum of the respective predetermined weights at least meeting a predetermined weight sum. The instructions are also executable to, based on the identification, permit an attempt at authentication using the one or more forms of authentication.

In another aspect, a method includes identifying at least a first mode of authentication associated with a first predetermined weight, identifying at least a second mode of authentication associated with a second predetermined weight, identifying a threshold, and permitting access at least in part based on the weights meeting the threshold.

In still another aspect, a computer readable storage medium that is not a transitory signal comprises instructions executable by a processor to identify at least a first mode of authentication associated with a first strength level, identify at least a second mode of authentication associated with a second strength level, identify a strength bar, and permit an attempt at authentication at least in part based on the first and second strength levels together meeting the strength bar.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is an example block diagram of a network of devices in accordance with present principles;

FIGS. 3 and 4 are flow charts of an example algorithm in accordance with present principles; and

FIGS. 5-9 are example user interfaces (UIs) in accordance with present principles.

### DETAILED DESCRIPTION

Without limitation, the description below describes an authentication system with a set of guidelines regarding various authentication strength levels. More specifically, each authentication mode to be used may be associated with a strength level that may be established by a system administrator, such as based on how hard the given authentication mode is for a hacker to guess or figure out. A user may attempt authentication using one or modes of authentication respectively associated with various strength levels so that the strength levels collectively meet a total strength bar/threshold, and the user may not be authenticated until valid authentication data is received for each mode used to meet the strength bar/threshold.

The user may be allowed to select the modes of authentication to use. Additionally or alternatively, modes of authentication available to be made available may be treated as a pool of candidates, and each time the user provides input to authenticate, a random selection of modes of authentication may be chosen such that the minimum strength bar/threshold is met.

Furthermore, if a user's initial authentication attempt fails, such as if the user mistyped his or her password three times before finally getting the password correct, the strength bar/threshold may be raised higher, which in turn may lead to the user having to provide authentication information using a different mode of authentication, such as providing a digital certificate. The modes of authentication that are used for each attempt may be the same as ones used in previous attempts or may be different from ones used in previous attempts.

Additionally, the strength bar may continue to rise if the user's attempts at authentication continue to fail. Once strength the bar is so high that the strength levels for the remaining modes of authentication would not be sufficient to meet the strength bar to allow the user to authenticate, then a password reset process may be initiated and/or the user may be locked out of the system to which they are attempting to gain access.

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

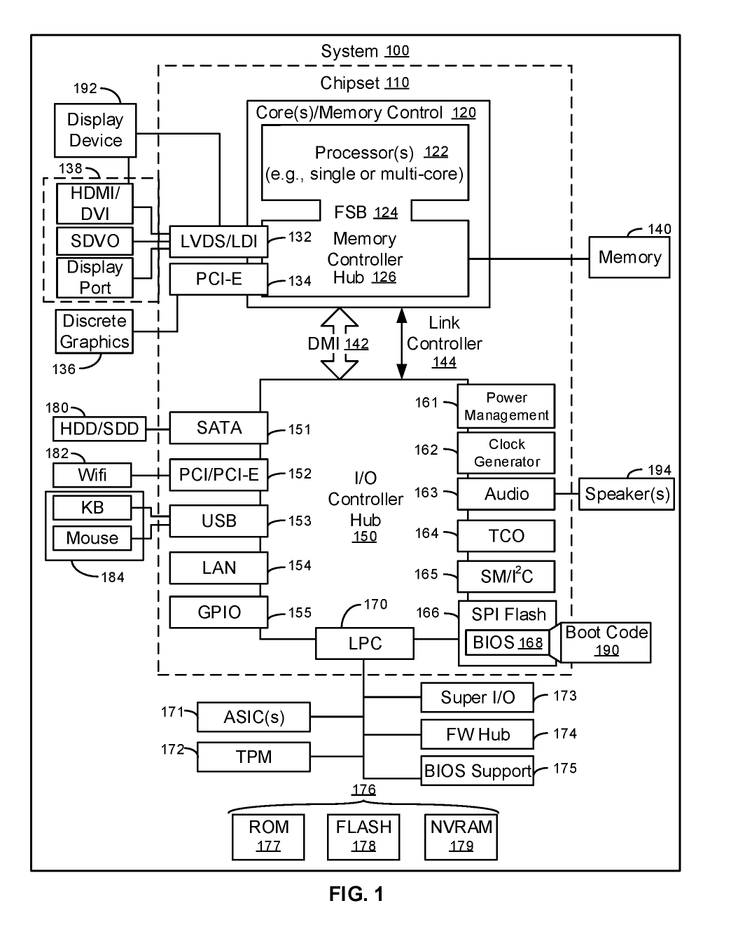

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.) and/or for input devices 184 to perform various types of authentication as set forth herein (e.g., fingerprint readers, keyboards, key card sensors, eye sensors, audio sensors, other biometric sensors, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for clarity, in some embodiments the system 100 may include a gyroscope that senses and/or measures the orientation of the system 100 and provides input related thereto to the processor 122. The system 100 may also include an accelerometer that senses acceleration and/or movement of the system 100 and provides input related thereto to the processor 122, as well as an audio receiver/microphone that provides input from the microphone to the processor 122 based on audio that is detected (such as via a user providing audible input to the microphone).

Still further, the system 100 may include a camera that gathers one or more images and provides input related thereto to the processor 122. The camera may be a thermal imaging camera, a digital camera such as a webcam, a three-dimensional (3D) camera, and/or a camera otherwise integrated into the system 100 and controllable by the processor 122 to gather pictures/images and/or video. Additionally, and also not shown for clarity, the system 100 may include a GPS transceiver that is configured to receive geographic position information from at least one satellite and provide the information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

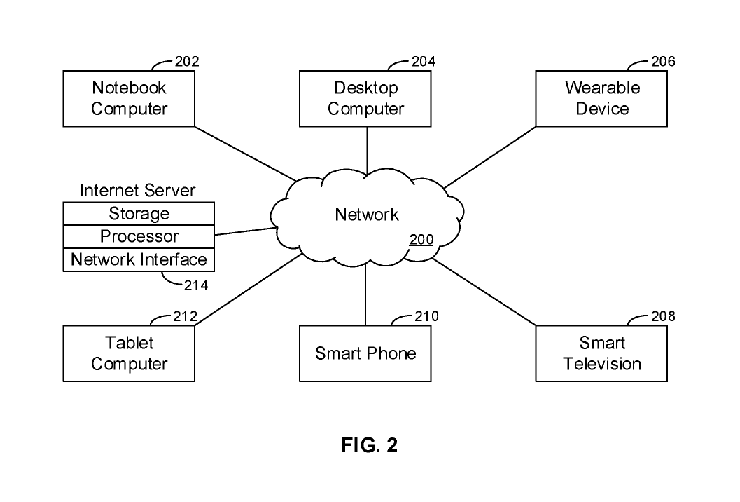

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

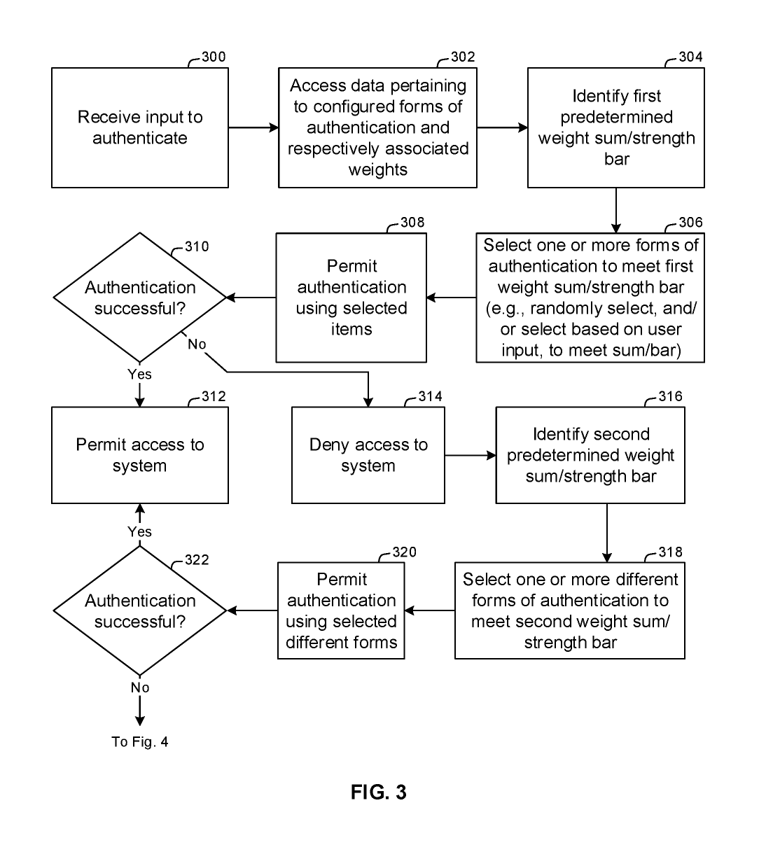

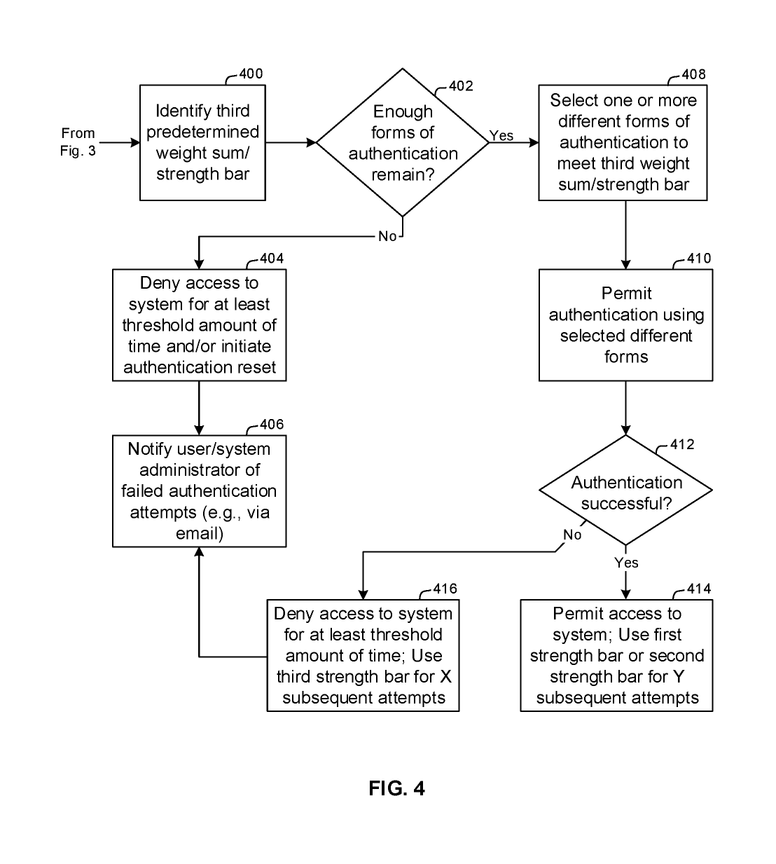

Referring to FIG. 3, it shows example logic that may be executed by a device such as the system 100 for authenticating a user in accordance with present principles. Beginning at block 300, the logic may receive input from the user to initiate authentication so that the user may log on to a given system, such as a particular device, a particular storage area, a particular network, a particular web-based portal or online service, etc. Responsive to the input received at block 300, the logic may move to block 302.

At block 302 the logic may access data pertaining to forms of authentication that have been configured or authorized for use, such as by a system administrator, to authenticate the user to the system. Each form of authentication may be respectively associated with a weight and/or strength level. Weights and/or strength levels will be referred to below simply as “weights” for simplicity. The weights may be defined by a system administrator, by the user, and/or by another person given access to establish the respective weights. Each weight may pertain to an authentication strength for the given form of authentication with which it is associated.

From block 302 the logic may proceed to block 304. At block 304 the logic may identify a first predetermined weight sum and/or strength bar for authentication that is to be met. Weight sums and/or strength bars will be referred to below simply as “weight sums” for simplicity. The first predetermined weight sum may be a default weight sum established by the user or system administrator, and/or may be a weight sum that is the lowest of the weight sums to be used for authentication as set forth further herein.

Note that both the data accessed at block 302 and first predetermined weight sum identified at block 304 may be stored in and identified from a storage location accessible to the device undertaking the logic of FIG. 3, as may the other weight data and weight sums disclosed herein. Additionally, it is to be understood that in some examples, particular forms of authentication may be respectively associated with given weights using a relational database accessible to the device undertaking the logic of FIG. 3.

From block 304 the logic may proceed to block 306. At block 306 the logic may select one or more of the forms of authentication accessed at block 302. The selection may be made, e.g., randomly but so that respective weights of the selected forms of authentication eventually add up at least to the first predetermined weight sum as they are randomly selected. Additionally or alternatively, the selection may be made based on a set of preconfigured rules for what forms of authentication should be used for meeting the first predetermined weight sum.

Providing an example, suppose the first predetermined weight sum is fifteen. Also suppose that a password form of authentication has an associated weight of ten, and that authentication using a key card has an associated weight of five. Based on those two weights adding up to fifteen and thus meeting the first predetermined weight sum, the logic may select those two forms of authentication for the user to use to authenticate himself or herself.

As another example, again suppose the first predetermined weight sum is fifteen. Also suppose that the password form of authentication has an associated weight of ten, and that a fingerprint form of authentication has an associated weight of eight. Based on those two weights being randomly selected first by a device undertaking present principles, and based on those two weights adding up to eighteen, the first predetermined weight sum of fifteen is met and actually exceeded by three since the sum of those two weights is eighteen. Thus, the logic may select those two forms of authentication for the user to use to authenticate himself or herself.

Still in reference to block 306, note that in addition to or in lieu of at least some forms of authentication being randomly selected or selected based on a predetermined protocol or algorithm, the forms of authentication may also be selected based on user input. For example, various forms of authentication having various respective weights may be presented on a user interface (UI) for selection by a user, with particular forms being selected for use for authentication at block 306 based on user input selecting them and based on the associated weights of the selected forms of authentication at least adding up the first predetermined weight sum. Further, in some examples, the user may not be allowed to move forward to attempt to authenticate himself or herself at least until the user selects enough forms of authentication to meet the first predetermined weight sum.

Based on selected forms of authentication meeting the first predetermined weight sum, the logic may move from block 306 to block 308. At block 308 the logic may present a UI permitting authentication using the selected forms, or otherwise prompt the user to authenticate himself or herself using the selected forms and enable such authentication. For example, for username and password authentication, a UI having input fields for a user name and password may be presented, and authentication performed based on whether input of a valid username and corresponding password have been input to the UI. As another example, for fingerprint authentication, a fingerprint reader may be enabled to receive fingerprint input from the user, and authentication performed based on whether input of a valid fingerprint is provided to the fingerprint reader.

Thus, after permitting authentication using the selected forms at block 308, the logic may receive authentication input from the user and move to decision diamond 310. At diamond 310 the logic may determine, based on the received authentication input from the user such as input of a password or fingerprint, whether the input is valid for authenticating the user to the system and hence whether authentication is successful. For example, the logic may compare a received user name and password to entries in a relational database associating valid user names with respective valid passwords, and then authentication may be successful based on the received user name and password matching an entry in the relational database. As another example, the logic may compare a received fingerprint scan to one or more fingerprint templates stored in a location accessible to the device undertaking the present logic, and then authentication may be successful based on the received fingerprint scan matching one of the templates at least within a predefined tolerance.

Responsive to an affirmative determination at diamond 310, the logic may proceed to block 312 where access may be permitted to the system the user is seeking to access. However, responsive to a negative determination at diamond 310, the logic may instead proceed to block 314. At block 314 the logic may deny access to the system and then proceed to block 316.

At block 316 the logic may identify a second predetermined weight sum that is to be met for a subsequent authentication attempt, and that may be higher than the first predetermined weight sum. For example, if the first predetermined weight sum is fifteen, the second predetermined weight sum may be seventeen.

From block 316 the logic may proceed to block 318. At block 318 the logic may select one or more of the forms of authentication to meet the second predetermined weight sum. The selection may be made, e.g., randomly but so that respective weights of the selected forms of authentication eventually add up at least to the second predetermined weight sum as they are randomly selected. The selection may also be made based on user input, and/or may be made based on a set of preconfigured rules for what forms of authentication should be used for meeting the second predetermined weight sum. Additionally, in some embodiments the selection at block 318 may be made such that at least one, if not all, forms of authentication selected at block 318 are different from those selected at block 306.

From block 318 the logic may then move to block 320. At block 320 the logic may permit authentication using the forms of authentication selected at block 318. After permitting authentication at block 320, the logic may receive authentication input from the user and move to decision diamond 322. At diamond 322 the logic may determine, based on the received authentication input from the user for the forms of authentication selected at block 318, whether the input is valid for authenticating the user to the system and hence whether authentication is successful.

Responsive to an affirmative determination at diamond 322, the logic may proceed to block 312 where access may be permitted to the system the user is seeking to access. However, responsive to a negative determination at diamond 322, the logic may deny access to the system and instead proceed to block 400, shown in FIG. 4.

At block 400 the logic may identify a third predetermined weight sum that is to be met for yet another authentication attempt, and that may be higher than the first and second predetermined weight sums. For example, if the first predetermined weight sum is fifteen and the second predetermined weight sum is seventeen, the third predetermined weight sum may be twenty.

From block 400 the logic may proceed to decision diamond 402. At diamond 402 the logic may determine whether one or more forms of authentication remain for permitting authentication of the user, such as in embodiments where different forms of authentication are to be used for each attempt at authentication. However, in embodiments where the same forms may be used for subsequent authentication attempts, the logic may instead proceed either from diamond 322 directly to block 404, or from block 400 directly to block 408, which will be described below.

Still in reference to diamond 400, it is to be understood that the determination regarding whether enough forms of authentication remain for permitting authentication of the user may be made based on whether there are enough available forms of authentication left that have not been used yet during the process set forth herein, and that have respectively associated weights that together collectively add up to the third predetermined weight sum.

Responsive to a negative determination at diamond 402, the logic may proceed to block 404. At block 404 the logic may deny access to the system for the user for at least a threshold amount of time, such as twenty four hours. Accordingly, authentication of the user using any forms/modes of authentication that have been configured for the user may not be permitted for at least the threshold amount of time.

Additionally or alternatively, but still at block 404, the logic may initiate an authentication reset for the user. The user may thus be prompted to reestablish his or her authentication credentials for at least one, or even all, forms of authentication that were used during the process set forth above, and/or that are associated with the user whether used in that particular process or not.

From block 404 the logic may then move to block 406 where the logic may notify the user and/or a system administrator of the failed authentication attempts, such as by sending an email indicating the failed authentication attempts, the times at which they occurred, the forms of authentication attempted to be used and their associated weights, the location and/or device at which the authentication was attempted, etc.

Referring back to decision diamond 402, responsive to an affirmative determination rather than a negative one, the logic may move from diamond 402 to block 408. At block 408 the logic may select one or more (e.g., different) forms of authentication to meet the third predetermined weight sum as described herein (e.g., randomly, based on user input, etc.).

From block 408 the logic may then move to block 410. At block 410 the logic may permit authentication using the forms of authentication selected at block 408. After permitting authentication at block 410, the logic may receive authentication input from the user for the forms of authentication selected at block 408 and then move to decision diamond 412. At diamond 412 the logic may determine, based on the received authentication input from the user, whether the input is valid for authenticating the user to the system and hence whether authentication is successful.

Responsive to an affirmative determination at diamond 412, the logic may proceed to block 414 where access may be permitted to the system the user is seeking to access. Also at block 414, a setting may be established to use either of the first weight sum or the second weight sum for a threshold number of subsequent authentication attempts using the user's authentication credentials.

For example, based on authentication failing at least once and/or access to the system being denied at least once as described above, the relatively higher second weight sum may be used for the threshold number of subsequent authentication attempts to provide enhanced security for the system. However, in other embodiments, a successful authentication may reset system security for the user's authentication credentials to an initial default level, and accordingly the first weight sum may be used for subsequent authentication attempts at least until another attempt at authentication using the user's credentials is unsuccessful, in which case a relatively higher weight sum may again be used as described herein.

Referring back to decision diamond 412 again, note that responsive to a negative determination at diamond 412, the logic may move to block 416 where the logic may deny access to the system for at least a threshold amount of time, which may be the same as or different from (e.g., more than) the threshold amount of time described above in reference to block 404. Also at block 416, a setting may be established to use the third weight sum for a threshold number of subsequent authentication attempts using the user's authentication credentials, with this threshold number being the same as or different from (e.g., more than) the threshold number of subsequent authentication attempts described above in reference to block 414. From block 416 the logic may then proceed to block 406 and provide a notification as described above.

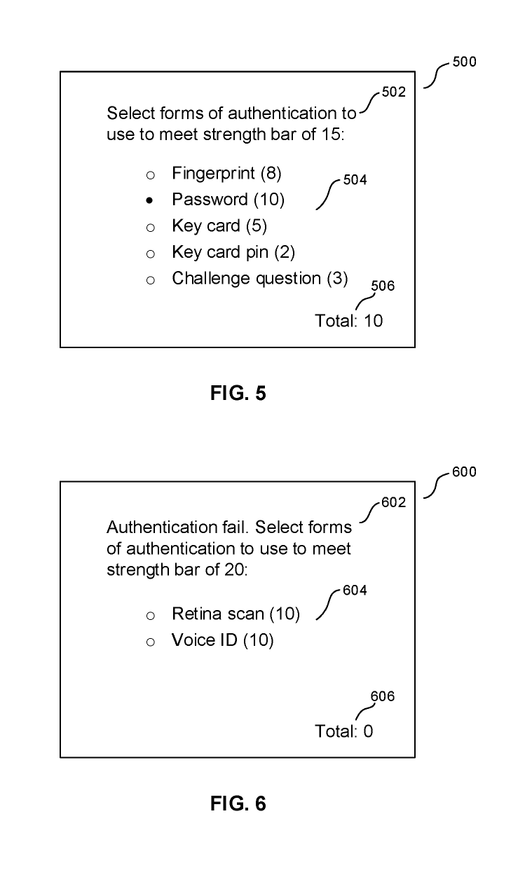

Now describing FIG. 5, it shows an example user interface (UI) 500 presentable on a display accessible to a device undertaking present principles, such as one executing the logic discussed above in reference to FIGS. 3 and 4. The UI 500 may be for prompting a user to select one or more forms or types of authentication to use to authenticate himself or herself to a system such as a particular network, device, or online service. Accordingly, the UI 500 may include a prompt 502 requesting a user select one or more forms of authentication to meet a weight sum/strength bar indicated in the prompt 502, which in this example is a weight sum/strength bar of fifteen.

The UI 500 may also include plural options 504 that are selectable, using the respective radio button shown adjacent to each one, to perform authentication of the user using the respective authentication type for each option 504. In the example shown, example authentication types include fingerprint authentication, password authentication, authentication using a key card or other radio frequency identification (RFID)/wireless chip authentication, key card pin authentication in which a pin associated with the key card is to be entered, and challenge question authentication in which a question is asked for authentication that pertains to the user such as what city the user was born in or what is the user's mother's maiden name.

Additionally, it is to be understood that in some embodiments the plural options 504 that are presented may reflect some, but not all, available forms of authentication to authenticate the user, with the user only being allowed to choose between the listed types but not other available types that are unlisted. In such an embodiment, each time the list of options is presented, different combinations of forms of authentication may be presented.

In any case, note that each option 504 as shown in FIG. 5 may include an accompanying indication in parenthesis indicating a weight/strength level associated with the respective option. Also note that a total weight sum/strength bar indicator 506 is shown pertaining to the total weight sum/strength bar for the options that are currently selected. In this example, because only the password option with a strength level of ten has been selected so far, the indicator 506 indicates that options having a total weight sum/strength bar of ten have been selected. Further, in some embodiments the user may not be allowed to proceed to authenticating himself or herself using the selected authentication types until the weight sum/strength bar is met as reflected by the indicator 506.

The UI 500 of FIG. 5 may be an example of a UI to be presented for a user to select one or more forms of authentication to use to meet the first predetermined weight sum discussed above in reference to FIG. 3. Thus, it may be appreciated based on FIG. 5 that a user may meet a base authentication strength bar by choosing to authenticate with one or two relatively strong factors, or a greater combination of factors including some relatively weaker factors.

Now referring to FIG. 6, it shows an example UI 600 presentable on a display to also prompt a user to select one or more forms or types of authentication to use to authenticate himself or herself to a system in accordance with present principles. The UI 600 may include a prompt 602 indicating that a previous attempt at authentication failed, and requesting a user select one or more forms of authentication to meet a weight sum/strength bar indicated in the prompt 602, which in this example is a strength bar of twenty. Thus, it is to be understood that the example UI 600 shown in FIG. 6 may be presented after the UI 500 shown in FIG. 5 is presented and during a single authentication process if, for example, authentication failed when the user tried to authenticate using modes listed on the UI 500 that were selected by the user. Thus, the failed attempt to authenticate has led to the weight sum/strength bar being raised from fifteen to twenty.

As may be appreciated form FIG. 6, the UI 600 may include options 604 that are selectable, using the respective radio button shown adjacent to each one, to perform authentication of the user using the respective authentication type for each option 604. In the example shown, the user is not given much latitude to select forms of authentication to meet the strength bar of twenty, but instead two options each having a strength level of ten are indicated on the UI 600 and each should be selected in order for the user to authenticate himself or herself using the strength bar of twenty. As may be appreciated from FIG. 6, the example authentication types presented on the UI 600 are retina scan authentication and voice identification authentication.

The UI 600 may also include a total weight sum/strength bar indicator 606 pertaining to the weight sum/strength bar for the options that are currently selected from the UI 600. In the present example, because no options have been selected yet, the indicator 606 indicates that options having a total weight sum/strength bar of zero have so far been selected. Further, in some embodiments the user may not be allowed to proceed to authenticating himself or herself using the selected authentication types until the weight sum/strength bar is met as reflected by the indicator 606.

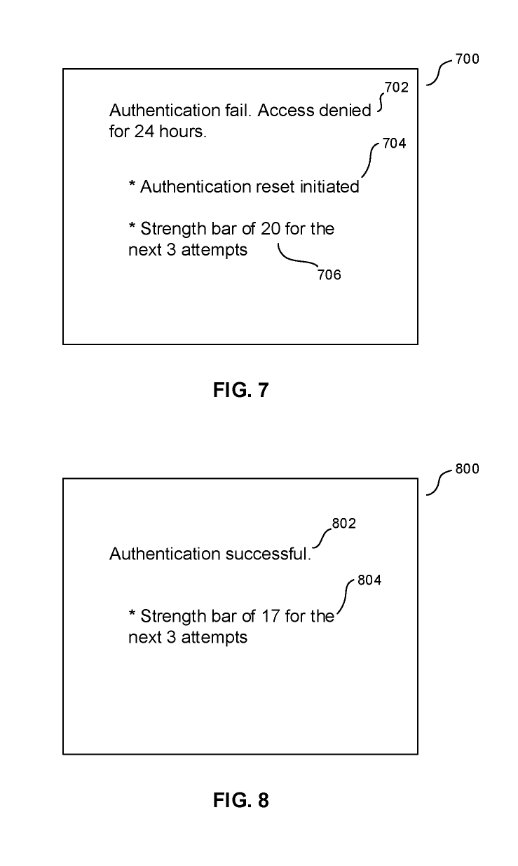

Reference is now made to FIG. 7. It shows an example UI 700 presentable on a display based on two or more attempts at authentication failing, with the latter attempt having to meet a higher strength bar than the initial attempt, though in other embodiments the UI 700 may be presented based on a single attempt failing. In any case, the UI 700 may include an indication 702 that authentication has failed and that access to the system sought to be accessed will be denied using the user's authentication credentials (e.g., for any available type of authentication) for at least a threshold amount of time, which in the present example is twenty four hours.

The UI 700 may also include an indication 704 that an authentication reset has been initiated. Still further, the UI 700 may include an indication 706 that a strength bar of twenty will have to be met for the next three processes for authenticating the user based on the failed authentication attempt. Had the attempt at authentication not failed as indicated by indicator 702, the strength bar to be subsequently met may have been lower. An example of this is shown in FIG. 8.

Accordingly, FIG. 8 shows a UI 800 including an indication 802 that an attempt at authentication using one or more selected modes of authentication has been successful. The UI 800 also includes an indication 804 that a strength bar of seventeen will have to be met for the next three processes to authenticate the user based on a first failed authentication attempt but a second successful authentication attempt. Had authentication been successful via the first attempt, the strength bar may have remained at a lower level (e.g., fifteen), but since the first attempt failed, the intermediate level of seventeen will have to be met for the next three authentication processes.

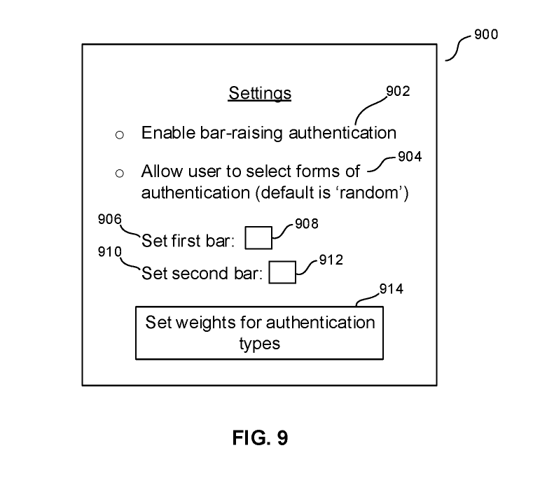

Continuing the detailed description in reference to FIG. 9, it shows an example UI 900 presentable on a display accessible to a device undertaking present principles to configure authentication settings. The UI 900 may include a first option 902 that is selectable using the radio button shown adjacent thereto to enable “bar-raising” authentication as disclosed herein. For example, the first option 902 may be selected to enable authentication to be performed in accordance with the logic set forth above in reference to FIGS. 3 and 4.

The UI 900 may also include a second option 904 that is selectable using the radio button shown adjacent thereto to allow a user to select forms of authentication to use for a given authentication attempt, rather than the device selecting forms for the user, which is the default in this example. However, rather than being a default, in other embodiments the UI 900 may include an option that is selectable to disallow a user from selecting forms of authentication for a given authentication attempt and, rather, have the device select various forms of authentication to use to meet a given strength bar (e.g., based on a predetermined protocol).

The UI 900 may also include options 906, 910 to set gradually increasing weight sums/strength bars to use for authentication attempts in accordance with present principles. Thus, a first strength bar may be set by providing input to input box 908, while a second, higher strength bar may be set by providing input to input box 912. Also, note that although only two such options are shown, a third strength bar option may also be presented for configuration of a third strength bar in a similar way.

FIG. 9 also shows that a selector 914 may be included on the UI 900. The selector 914 may be selectable to cause another UI to be presented at which a user/system administrator may establish weights/strength levels for various forms of authentication.

Moving on from FIG. 9, it is to be understood in accordance with present principles that an initial weight sum/strength bar that is to be used may also vary based on what level of access a given user has to a system, and/or what level of access the user is seeking. For example, if the user is merely logging on to a device to play a video game, a relatively lower initial strength bar may be used than if the user were logging on to the same device to access a secured storage area.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory signal and/or a signal per se.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
a processor; and
storage accessible to the processor and bearing instructions executable by the processor to:
identify one or more forms of authentication each associated with a respective predetermined weight, the identification of the one or more forms of authentication being based at least in part on the sum of the respective predetermined weights at least meeting a predetermined weight sum; and
based on the identification, permit an attempt at authentication using the one or more forms of authentication.

2. The device of claim 1, wherein the one or more forms of authentication are identified based at least in part on user input to use the one or more forms of authentication, the user input directed to a user interface (UI) presented on a display accessible to the processor.

3. The device of claim 1, wherein the one or more forms of authentication are identified by the device.

4. The device of claim 3, wherein the one or more forms of authentication are identified by the device randomly.

5. The device of claim 1, wherein the instructions are executable by the processor to:
identify at least a first form of authentication associated with a first predetermined weight and a second form of authentication associated with a second predetermined weight, the identification of at least the first and second forms of authentication being based at least in part on the sum of the first and second predetermined weights at least meeting the predetermined weight sum; and
based on the identification, permit the attempt at authentication using at least the first and second forms of authentication.

6. The device of claim 1, wherein the instructions are executable by the processor to:
responsive to the attempt at authentication being successful, permit a first level of access to a system; and
responsive to the attempt at authentication failing, deny the first level of access to the system.

7. The device of claim 1, wherein the predetermined weight sum is a first predetermined weight sum, wherein the attempt at authentication is a first attempt at authentication, and wherein the instructions are executable by the processor to:
based on the first attempt at authentication failing, use a second predetermined weight sum to permit a second attempt at authentication, the second attempt at authentication being permitted using one or more forms of authentication each associated with a respective predetermined weight that together at least meet the second predetermined weight sum, the second predetermined weight sum being higher than the first predetermined weight sum.

8. The device of claim 7, wherein at least one form of authentication used for the second attempt at authentication is different from the one or more forms authentication used for the first attempt at authentication.

9. The device of claim 8, wherein the instructions are executable by the processor to:
based on the second attempt at authentication failing, determine whether one or more forms of authentication remain that are each associated with a respective predetermined weight that together at least meet a third predetermined weight sum to permit a third attempt at authentication using the remaining forms of authentication, the remaining forms of authentication not having been used in the first and second attempts at authentication.

10. The device of claim 9, wherein the instructions are executable by the processor to:
responsive to a determination that one or more forms of authentication do not remain that are each associated with a respective predetermined weight that together at least meet the third predetermined weight sum, initiate a reset of one or more forms of authentication.

11. The device of claim 9, wherein the instructions are executable by the processor to:
responsive to a determination that one or more forms of authentication do not remain that are each associated with a respective predetermined weight that together at least meet the third predetermined weight sum, deny access to a system for at least a threshold amount of time.

12. The device of claim 9, wherein the instructions are executable by the processor to:
responsive to a determination that one or more forms of authentication do not remain that are each associated with a respective predetermined weight that together at least meet the third predetermined weight sum, transmit a notification regarding the attempts at authentication.

13. A method, comprising:
identifying at least a first mode of authentication associated with a first predetermined weight;
identifying at least a second mode of authentication associated with a second predetermined weight;
identifying a threshold; and
permitting access at least in part based on the weights meeting the threshold.

14. The method of claim 13, wherein the threshold is a first threshold, and wherein the method comprises:
responsive to not permitting access at least in part based on the weights meeting the first threshold, identifying at least a third mode of authentication associated with a third predetermined weight, identifying at least a fourth mode of authentication associated with a fourth predetermined weight, and identifying a second threshold; and
permitting access at least in part based on the weights meeting the second threshold.

15. The method of claim 14, comprising:
responsive to not permitting access at least in part based on the weights meeting the second threshold, determining whether one or more modes of authentication remain that are each associated with a respective predetermined weight that together at least meet a third threshold to permit access using the remaining modes of authentication; and
permitting, responsive to determining that one or more modes of authentication remain that are each associated with a respective predetermined weight that together at least meet the third threshold, access at least in part based on the weights meeting the third threshold.

16. The method of claim 15, comprising:
using, based on permitting access at least in part based on the weights meeting the third threshold, one of the first threshold and the second threshold to subsequently permit access.

17. The method of claim 15, comprising:
preventing, responsive to determining that one or more modes of authentication do not remain that are each associated with a respective predetermined weight that together at least meet the third threshold, access and taking another predefined action.

18. The method of claim 15, comprising:
using the third threshold for at least a predetermined number of subsequent access attempts.

19. A computer readable storage medium that is not a transitory signal, the computer readable storage medium comprising instructions executable by a processor to:
identify at least a first mode of authentication associated with a first strength level;
identify at least a second mode of authentication associated with a second strength level;
identify a strength bar; and
permit an attempt at authentication at least in part based on the first and second strength levels together meeting the strength bar.

20. The computer readable storage medium of claim 19, wherein the instructions are executable by the processor to:
responsive to the attempt at authentication failing, raise the strength bar.
